(19) United States
(12) Patent Application Publication
(10) Pub. No.: US 2008/0272048 A1
(43) Pub. Date: Nov. 6, 2008

(54) Filter cartridge media retention system

(75) Inventors: Jason Mei, Overland Park, KS (US); Paul Santana Henry, Lee's Summit, MO (US); Alan Smithies, Overland Park, KS (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: BHA Group, Inc.

(21) Appl. No.: 11/799,189

(22) Filed: May 1, 2007

(51) Int. Cl. B01D 27/07; B01D 27/08

(52) U.S. Cl. 210/493.2

(57) ABSTRACT

A filter cartridge comprises a pleat pack including filtration media for removing particulates from a particulate laden fluid stream moving in a first direction through the filtration media. The pleat pack is formed into a tubular configuration with a plurality of circumferentially spaced pleats. The filtration media is periodically subject to a cleaning fluid stream moving in a second direction opposite to the first direction. Potting material is at axially opposite end portions of the pleat pack to maintain the filtration media in the tubular configuration. A support tube is located on a first side of the pleat pack downstream of the filtration media in the first direction of fluid flow. A retention device limits movement of a portion of the filtration media when subjected to the periodic cleaning fluid stream. The retention device comprises a metal band and located on a second side of the filtration media opposite the first side. A rod is disposed in the potting material of at least one of the axial end portions of the pleat pack. The rod is fixed to the metal band to maintain the metal band in an axial position along the filtration media.

### BACKGROUND OF THE INVENTION

The present invention relates generally to a filter cartridge. In particular, the present invention relates to a retention system for filtration media of the filter cartridge.

Filter cartridges are known that have pleated filtration media for filtering particulates from a particulate laden fluid stream moving in one direction through the filter cartridge. Such a filter cartridge is often subjected to cleaning fluid pulses moving for short periods of time through the filtration media in a direction opposite to the direction that the particulate laden fluid stream usually moves. Such a filter cartridge is referred to as a “pulse pleat” filter cartridge. Known fabric retention straps typically encircle portions of the pulse pleat filter cartridge to prevent a portion of the filtration media from excessive radial movement during exposure to the cleaning fluid pulses.

However, the known retention straps for pulse pleat filter cartridges have drawbacks because they are difficult to install onto a filter cartridge and may not be able to withstand relatively high operating temperatures and chemically active gas streams.

Extruded thermoplastic polyester elastomer retention straps have been introduced to overcome the disadvantages associated with known retention systems. However, even the extruded thermoplastic polyester elastomer retention straps have limitations when continuously exposed to relatively high operating temperatures. Thus, a need exists for a filter cartridge and filtration media retention system that can continuously operate in a “chemically active” or corrosive gas stream at temperatures of 300° F. and greater.

### SUMMARY OF THE INVENTION

One aspect of the present invention is directed to a pulse pleat filter cartridge that can withstand relatively high operating temperatures. The filter cartridge includes a pleat pack having filtration media for removing particulates from a particulate laden fluid stream moving in a first direction through the filtration. The pleat pack is formed into a tubular configuration with a plurality of circumferentially spaced pleats. The filtration media is periodically subject to a cleaning fluid stream moving in a second direction opposite to the first direction. Potting material is at axially opposite end portions of the pleat pack to maintain the pleat pack in the tubular configuration. A support tube is located on a first side of the pleat pack downstream of the filtration media in the first direction of fluid flow. A retention device limits movement of a portion of the filtration media when subjected to the periodic cleaning fluid stream. The retention device comprises a metal band and located on a second side of the filtration media opposite the first side. A rod is disposed in the potting material of at least one of the axial end portions of the pleat pack. The rod is fixed to the metal band to maintain the metal band in an axial position along the filtration media.

Another aspect of the present invention is directed to a filter cartridge including a pleat pack with filtration media for removing particulates from a particulate laden fluid stream moving in a first direction through the filtration media. The pleat pack is formed into a tubular configuration with a plurality of circumferentially spaced pleats. The filtration media is periodically subject to a cleaning fluid stream moving in a second direction opposite to the first direction. Potting material is at axially opposite end portions of the pleat pack to maintain the pleat pack in the tubular configuration. A support tube is located on a first side of the pleat pack downstream of the filtration media in the first direction of fluid flow. A first retention device to limits movement of a first portion of the filtration media when subjected to the periodic cleaning fluid stream. The first retention device comprises a first metal band and located on a second side of the filtration media opposite the first side. A first rod has an end portion disposed in the potting material at a first axial end of the pleat pack. The first rod is fixed to the first metal band to resist axial movement of the first metal band. A second retention device limits movement of a second portion of the filtration media when subjected to the periodic cleaning fluid stream. The second retention device comprises a second metal band and is located on a second side of the filtration media opposite the first side. A second rod is fixed to the first metal band and has an end portion disposed in the potting material at a second axial end of the pleat pack to resist axial movement of the second metal band.

Another aspect of the present invention is directed to an improved filter cartridge for removing particulates from a particulate laden fluid stream moving in a first direction through the filter cartridge. The filter cartridge is periodically subject to cleaning fluid stream moving in an second direction opposite to the first direction. The filter cartridge includes a pleat pack having filtration media formed into a tubular configuration with a plurality of circumferentially spaced pleats. Axially opposite end portions of the pleat pack are disposed in potting material. The improvement comprises a retention device to limit movement of a portion of the filtration media when subjected to the periodic cleaning fluid stream. The retention device comprising a metal band maintained in an axial position along the filtration media by a rod fixed to the metal band and having an end portion disposed in the potting material of at least one of the axial end portions of the pleat pack.

### BRIEF DESCRIPTION OF THE DRAWINGS

Further features of the present invention will become apparent to those skilled in the art to which the present invention relates from reading the following description with reference to the accompanying drawings, in which:

FIG. 1 is an elevational view, partly in section, of a filter cartridge incorporating retention system according to one aspect of the present invention;

FIG. 2 is a perspective view of the retention system of the filter cartridge illustrated in FIG. 1;

FIG. 3 is a sectional view of the retainer of the retention system illustrated in FIG. 2; and

FIG. 4 is an enlarged cross-sectional view of a portion of the retention system of the filter cartridge, taken approximately along line 4-4 in FIG. 1.

### DESCRIPTION OF PREFERRED EMBODIMENTS

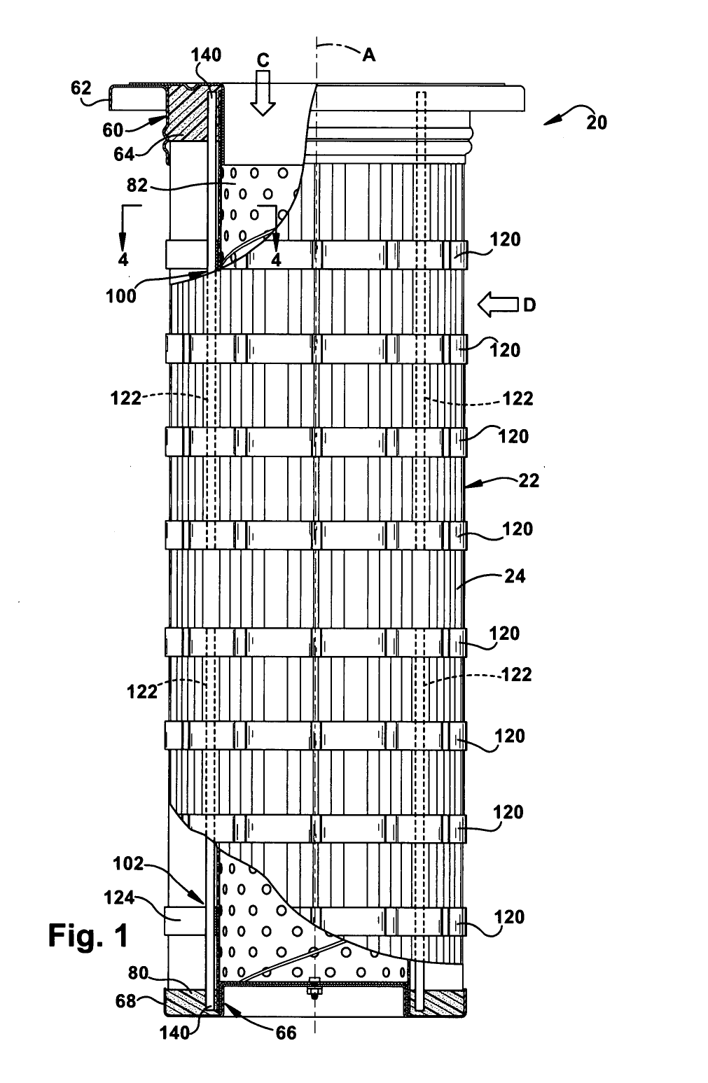

One aspect of the present invention is embodied in a filter cartridge 20 (FIG. 1) for removing particulates from a particulate laden fluid stream moving in one direction D through the filter cartridge, from the exterior to the interior. The filter cartridge 20 is particularly suitable for continuous use in air pollution control applications at relatively high temperatures. The filter cartridge 20 is a “pulse pleat” type of filter cartridge that is periodically subject to pulsed cleaning fluid stream moving in a direction C, opposite to the direction D that the particulate laden fluid stream moves, as is known. Such a filter cartridge 20 may be subjected to over several hundred thousand cleaning pulses per year over a typical expected service life of about two years. The filter cartridge 20 is suitable for use in cement, lime and industrial boiler applications where the continuous operating temperature can reach up to about 500° F. The filter cartridge 20 is operably attached to a tube sheet (not shown) in a baghouse in a known manner.

The filter cartridge 20 includes a pleat pack 22 with filtration media 24 that is formed into a generally tubular or cylindrical configuration, as illustrated in FIG. 1. “Pleat pack” as used herein is intended to mean the entire tubular component while “filtration media” means only the portion of the pleat pack that fluid may flow through. The filter cartridge 20 has a longitudinal central axis A. The filtration media 24 has a plurality of pleats 26 (FIG. 4) which are spaced about the periphery of the filter cartridge 20.

Each pleat 26 has a tip 42 formed at its radially outermost location, as viewed in FIG. 4. A pair of sides 44 extend radially inward from the tip 42. The sides 44 meet and form a base 46 of each pleat 26. The pleats 26 in the filtration media 24 are not necessarily stiff and strong, thus, the pleats are prone to radially outward movement during a cleaning fluid pulse. Excessive radial outward movement of the filtration media 24 can damage the filtration effectiveness of the filter cartridge 20.

Adjacent pleats 26 may also “collapse” and temporarily engage one another during a cleaning pulse or during a filtration cycle. When adjacent pleats 26 engage one another, there is a chance that the cleaning pulse or filtration operation will not be as effective as it should be because gas flow through that portion of the filtration media 24 can be temporarily blocked. Thus, it is desirable to prevent excessive radial movement of the filtration media 24 during a cleaning pulse and minimize collapse of the pleats 26.

The filtration media 24 is made of any suitable material for the environment the filter cartridge 20 will be used in. For example, the filter cartridge 20 may be used continuously in a relatively high temperature application such as up to about 500° F. Thus, the selected material for the filtration media 24 may be glass or polytetraflouroethylene (PTFE) fibers. If fine filtration is desired a PTFE membrane may be applied to the fibers.

Mounting structure 60 (FIG. 1) is located at a first axial end portion of the pleat pack 22 and filter cartridge 20. The mounting structure 60 includes a metal cap 62 and potting material 64 for mounting and sealing the filter cartridge 20 in an opening in the tube sheet 22. A known suitable material for the cap 62 is standard steel or galvanized steel. The potting material 64 is preferably selected from a material capable of withstanding the elevated operating temperatures that the filter cartridge 20 will be exposed to. Such a material is a one component epoxy material that cures to a Shore D hardness of about 83.

An end cap 66 is located at an axially opposite second axial end portion of the pleat pack 22 and filter cartridge 20. The end cap 66 includes a metal cup 68 made from the same steel as cap 62. Potting material 80, similar to the potting material 64 fills a portion of the cup 68. The pleat pack 22 is potted and maintained in the generally tubular configuration by the mounting structure 60, end cap 66 and potting material 64, 80.

A permeable support tube 82 (FIGS. 1 and 4) is located radially inward of the pleat pack 22 to prevent inward collapse of the filtration media 24 during exposure to the particulate laden fluid stream D that is to be filtered. The support tube 82 has its axial opposite ends located in the potting material 64, 80.

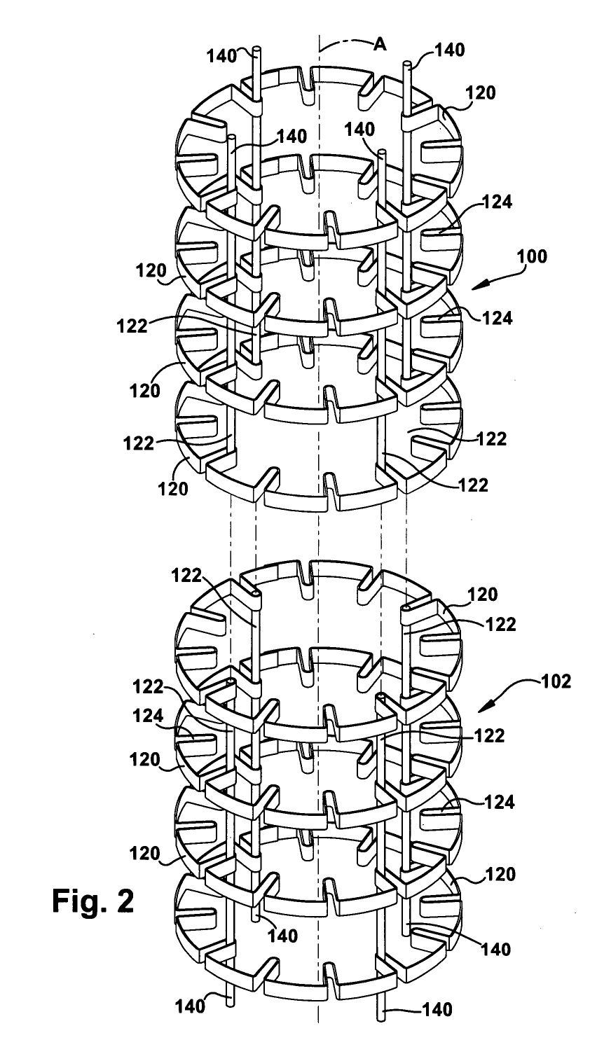

The filter cartridge 20 also includes two retention systems 100, 102 (FIGS. 1-2), constructed according to one aspect the present invention. The retention systems 100, 102 limit movement of portions of the filtration media 24 in the radially outward direction, when subjected to the periodical cleaning fluid pulse C and minimize pleat collapse.

Each of the retention systems 100, 102 is preferably made from a steel material such as mild steel or galvanized steel. The retention systems 100, 102 have sufficient strength and fatigue resistance to prevent excessive movement of the filtration media 24 during a cleaning pulse C. The retention system 100, 102 are capable of withstanding the elevated operating temperatures and operating environment, such as exposure to moisture and chemical corrosives, that the filter cartridge 20 is typically exposed to and designed for.

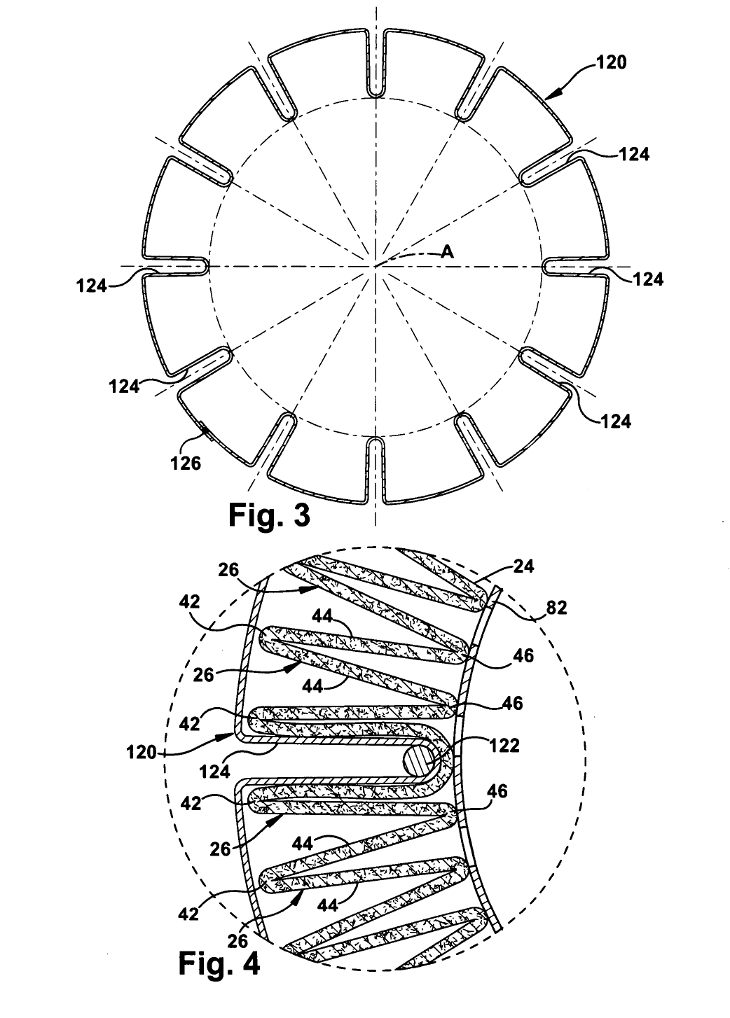

Each of the retention systems or devices 100, 102 includes four metal bands 120 and four metal rods 122 (best seen in FIG. 2). Each metal band 120 has a plurality of recesses 124 (FIG. 3) formed therein. The recesses 124 extend for a distance radial inward from the outer periphery of the metal band 120. The metal band 120 is formed from a strip of steel. Ends of the steel strip are overlapped and permanently attached together, such as by a weld 126.

A recess 124 receives a rod 122, as illustrated in FIG. 4. The rod 122 is fixed to the metal band 120 in the recess 124, such as by welding, to resist movement of the metal bands relative to the rod and filtration media 24 of the filter cartridge 20. The rods 122 are equally spaced about the periphery of the filter cartridge 20. The number of recesses 124 and rods 122, as well as the spacing of the rods, may vary from the aspect illustrated and described.

The metal band 120 is formed to have an interior size that is slightly greater than the outer dimension of the filtration media 24 when it is formed into its tubular configuration. The recesses 124 of the metal band 120 fit between adjacent pleats of the filtration media 24. The innermost diameter of the recesses 124 is sized to hold the filtration media 24 against the support tube 82. The rods 122, thus, extend in a direction substantially parallel to the longitudinal central axis A of the filter cartridge 20 within the pleat 26 of the filtration media 24.

Each metal band 120 limits radial outward movement of a portion of the filtration media 22 in the proximity of the metal band during the application of a cleaning pulse C. This limitation assures that the filtration media 24 does not over-stress during cleaning. The filtration media 24, thus, can have a relatively long service life and operate in the conditions it was designed for.

Each rod 122 has an end portion 140 (FIG. 1) that is located in the potting material 64, 80 at each axial end portion of the pleat pack 22. This anchors the rods 122 and retention systems 100, 102 so the metal bands 120 do not move axially relative to the filtration media 24.

From the above description of preferred embodiments of the invention, those skilled in the art will perceive improvements, changes and modifications. Such improvements, changes and modifications within the skill of the art are intended to be covered by the appended claims.

Having described at least one preferred embodiment of the invention, what is claimed is:

1. A filter cartridge comprising:
a pleat pack including filtration media for removing particulates from a particulate laden fluid stream moving in a first direction through the filtration media the pleat pack formed into a tubular configuration with a plurality of circumferentially spaced pleats, the filtration media periodically subject to a cleaning fluid stream moving in a second direction opposite to the first direction,
potting material at axially opposite end portions of the pleat pack to maintain the pleat pack in the tubular configuration;
a support tube located on a first side of the pleat pack downstream of the filtration media in the first direction of fluid flow; and
a retention device to limit movement of a portion of the filtration media when subjected to the periodic cleaning fluid stream, the retention device comprising:
a metal band and located on a second side of the filtration media opposite the first side; and
a rod disposed in the potting material of at least one of the axial end portions of the pleat pack, the rod fixed to the metal band to maintain the metal band in an axial position along the filtration media.

2. The filter cartridge of claim 1 wherein the metal band has at least one recess that is extendable between adjacent pleats.

3. The filter cartridge of claim 2 wherein the rod is receivable in and fixed to the recess of the metal band.

4. The filter cartridge of claim 1 wherein the rod has a second end disposed in the potting material of a second axial end portion of the pleat pack.

5. The filter cartridge of claim 1 further including a plurality of rods fixed to the metal band and wherein the rods are equally spaced about the periphery of the filter cartridge.

6. The filter cartridge of claim 1 wherein said metal band can withstand continuous operating temperatures up to about 500° F.

7. The filter cartridge of claim 1 further including a plurality of retention devices spaced axially along the extent of the filtration media and fixed to the rod.

8. The filter cartridge of claim 1 further including:
a second retention device to limit radial movement of a second portion of the filtration media when subjected to the periodic cleaning fluid stream, the second retention device comprising a metal band and located on the second side of the filtration media; and
a second rod having an end portion disposed in the potting material at a second axial end of the pleat pack, the second rod fixed to the second metal band to maintain the second metal band in a second axial position along the filtration media.

9. A filter cartridge comprising:
a pleat pack including filtration media for removing particulates from a particulate laden fluid stream moving in a first direction through the filtration media the pleat pack formed into a tubular configuration with a plurality of circumferentially spaced pleats, the filtration media periodically subject to a cleaning fluid stream moving in a second direction opposite to the first direction;
potting material at axially opposite end portions of the pleat pack to maintain the pleat pack in the tubular configuration;
a support tube located on a first side of the pleat pack downstream of the filtration media in the first direction of fluid flow;
a first retention device to limit movement of a first portion of the filtration media when subjected to the periodic cleaning fluid stream, the first retention device comprising a first metal band and located on a second side of the filtration media opposite the first side;
a first rod having an end portion disposed in the potting material at a first axial end of the filtration media, the first rod fixed to the first metal band to resist axial movement of the first metal band;
a second retention device to limit movement of a second portion of the filtration media when subjected to the periodic cleaning fluid stream, the second retention device comprising a second metal band and located on a second side of the filtration media opposite the first side; and
a second rod fixed to the first metal band and having an end portion disposed in the potting material at a second axial end of the pleat pack to resist axial movement of the second metal band.

10. The filter cartridge of claim 9 wherein each of the metal bands has at least one recess that is extendible between adjacent pleats.

11. The filter cartridge of claim 10 wherein at least one of the rods is receivable in and fixed to the recess of at least one of the metal bands.

12. The filter cartridge of claim 9 further including a plurality of rods wherein the rods are equally spaced about the periphery of the filter cartridge.

13. The filter cartridge of claim 9 wherein said metal band can withstand continuous operating temperatures up to about 500° F.

14. The filter cartridge of claim 9 further including a plurality of retention devices spaced axially along the extent of the filtration media and fixed to at least one of the rods.

15. An improved filter cartridge for removing particulates from a particulate laden fluid stream moving in a first direction through the filter cartridge, the filter cartridge periodically subject to cleaning fluid stream moving in an second direction opposite to the first direction, the filter cartridge including a pleat pack including filtration media formed into a tubular configuration with a plurality of circumferentially spaced pleats, axially opposite end portions of the pleat pack disposed in potting material; the improvement comprising:
a retention device to limit movement of a portion of the filtration media when subjected to the periodic cleaning fluid stream, the retention device comprising a metal band maintained in an axial position along the filtration media by a rod fixed to the metal band and having an end portion disposed in the potting material of at least one of the axial end portions of the pleat pack.

16. The improved filter cartridge of claim 15 wherein the metal band has at least one recess that is extendable between adjacent pleats.

17. The filter cartridge of claim 16 wherein the rod is receivable in and fixed to the recess of the metal band.

18. The improved filter cartridge of claim 15 wherein the rod has a second end disposed in the potting material of the second axial end portion of the pleat pack.

19. The improved filter cartridge of claim 15 further including a plurality of rods wherein the rods are equally spaced about the periphery of the filter cartridge.

20. The improved filter cartridge of claim 15 further including:
a second retention device to limit radial movement of a second portion of the filtration media when subjected to the periodic cleaning fluid stream, the second retention device comprising a second metal band; and
a second rod having an end portion disposed in the potting material at a second axial end of the pleat pack, the second rod fixed to the second metal band to maintain the second metal band in a second axial position along the filtration media.
